(19) United States
(12) Patent Application Publication
(10) Pub. No.: US 2013/0036367 A1
(43) Pub. Date: Feb. 7, 2013

(54) Updating a user Interface

(71) Applicants: Stephen DeRoos, Vancouver, WA (US); Dennis Wilkinson, Los Altos, CA (US); William Hertling, Vancouver, WA (US); Kevin Eld, Boise, ID (US)

(72) Inventors: Stephen DeRoos, Vancouver, WA (US); Dennis Wilkinson, Los Altos, CA (US); William Hertling, Vancouver, WA (US); Kevin Eld, Boise, ID (US)

(21) Appl. No.: 13/642,376

(22) PCT Filed: Apr. 23, 2010
(86) PCT No.: PCT/US10/32162

§ 371 Date: Oct. 19, 2012

(51) Int. Cl. G06F 3/01

(52) U.S. Cl. 715/745

(57) ABSTRACT

A computerized method for updating a user interface is provided to receiving information indicative of the behavior of a plurality of previous users with respect to a user interface and determine, based on the received information, an updated version of the user interface likely to be useful. The method may further output data indicative of the updated version of the user interface.

### BACKGROUND

There is an ever increasing amount of information available through the use of computers and computer networks. As more information becomes accessible, it is desirable to have tools to make the information more manageable for computer users. Information retrieval methods, such as those used by Internet search engines, have been implemented to alter the manner in which information is displayed to users. However, it is desirable to have computer systems that further facilitate a computer user's ability to efficiently navigate through an abundance of available information.

### BRIEF DESCRIPTION OF THE DRAWINGS

In the accompanying drawings, like numerals refer to like components or blocks. The following detailed description references the drawings, wherein:

FIG. 1 is a block diagram illustrating one example of a computing system.

FIG. 2 is a flow chart illustrating one example of a method for updating a user interface.

FIG. 3 is a block diagram illustrating one example of updating a user interface.

FIG. 4 is a block diagram illustrating one example of updating a user interface.

### DETAILED DESCRIPTION

Methods have been developed to alter the way in which content appears on user interfaces. In some cases, search engines determine the likely relevance of information, for example based on links accessed by previous webpage users, and display information based on this relevance calculation. However, these methods may fail to account for whether a user interface enables a user to successfully find information or address an issue in an efficient manner. As a result, the user interface may present information in a manner or sequence that leads to cumbersome or time consuming navigation. In addition, some user interfaces are composed of static pages, which may limit the way in which a user interface may be updated.

In one embodiment, a method for updating a user interface analyzes behavior of previous users of a user interface, such as the order in which they selected items on the user interface, to determine an updated version of the user interface that is likely to be useful to future users. A useful user interface may present information in a manner that is directed to providing a solution, such as helping a user address an issue or find an answer to a question in a shorter amount of time. For example, a user interface may be directed to helping a user troubleshoot an issue with a computer, and the user interface may be updated in a manner that enables future users to more quickly find information directed to a suggested solution that is capable of fixing the user's actual computer issue.

A user interface may be tailored to a user issue, such as a topic or search request. In some cases, an updated user interface may be tailored to multiple user issues, for example, by having a first page addressing a first user issue and a second page addressing a second user issue. Each of the pages may be updated to better display information useful for the issue targeted by the particular page.

A user interface may be composed of components that may be dynamically updated in a manner predicted to be useful to future users. For example, the components of the user interface may be reorganized such that different components are displayed, displayed in a different order, or displayed in a different configuration upon initialization. In some cases, display information about an updated version of the user interface, such as an Extensible Markup Language (XML) file, is sent to off the shelf website publishing software to configure it for display on a user's computer.

An automated method for updating a user interface provides advantages. For example, a user interface may be updated to display information in a manner that is both relevant to a user's search and allows a user to find a solution to an issue more easily and quickly. By dividing the user interface into components, the usefulness of past versions of the user interface may be tracked more accurately, for example, by determining which components and structures of components were useful to previous users. Such an organization may also allow a user interface to dynamically address user issues without the limitations of static user interface pages. Updating a user interface tailored to multiple user issues may further increase the likelihood that users will find the user interface to be effective for addressing a particular issue. In addition, outputting display data that may be read by standard website publishing software may decrease the cost of implementing an automated solution for updating a user interface.

Providing a useful user interface may provide benefits in a variety of contexts, such as troubleshooting, marketing, or informational contexts. For example, in an informational context, such as an online encyclopedia or reference, information about viewed content and the length of viewing time could be used to determine an updated user interface that would be useful for future users. In the field of website support documents, a large amount of customer support information may be presented in a more useful manner. Some embodiments could decrease the cost and increase the effectiveness and efficiency of addressing customer issues, possibly providing an alternative solution to complex and expensive diagnostic and troubleshooting applications.

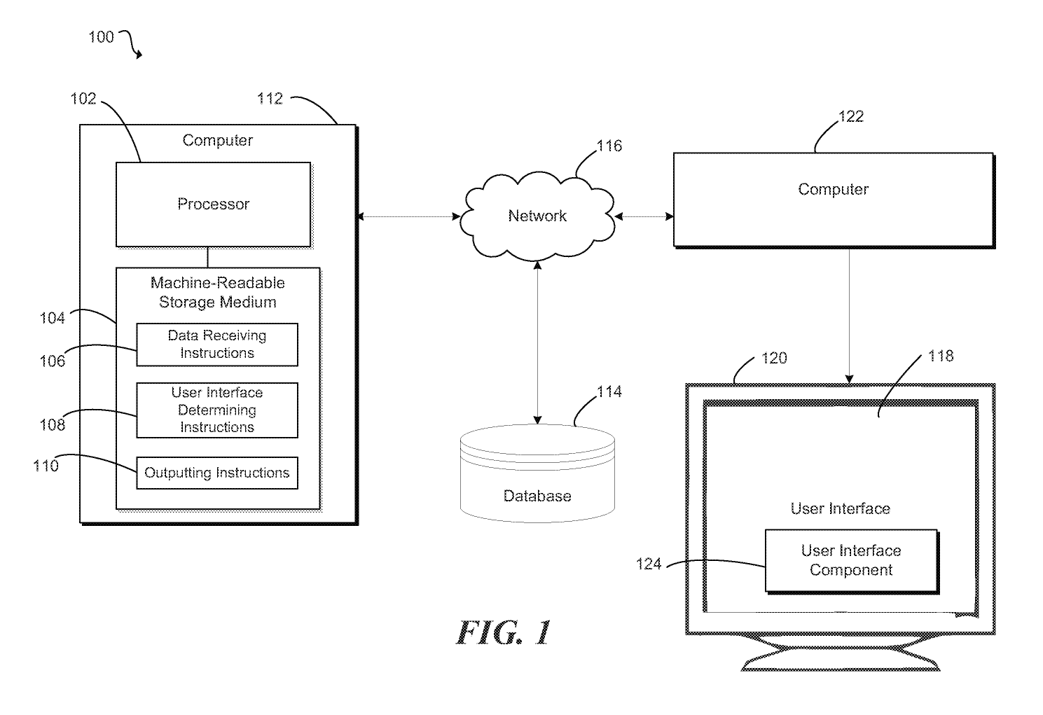

FIG. 1 is a block diagram illustrating one example of a computing system 100. The computing system 100 may include, for example, a computer 112, a computer 122, a display device 120, a network 112, and a database 114. The computer 122 may be any suitable computing device capable of retrieval and execution of instructions. In one embodiment, the computer 122 communicates with the computer 112 via the network 116, which may be any type of network, including an intranet or the Internet. The computer 122 may be connected to a display device 120, such as a computer monitor or a mobile phone screen.

The user interface 118 may be any suitable user interface, such as an online solution, diagnostic, troubleshooting, or informational user interface, and in some cases, it may be displayed on a website or intranet page. The user interface 118 may also be a graphical user interface displayed by a local computer program. The user interface 118 may be displayed on any suitable display device, such as the display device 120 or a display device connected to the computer 112.

In one embodiment, the user interface 118 includes multiple pages or documents that may be accessible from each other, for example, via hyperlinks. The user interface 118 may display one or more user interface components, such as the user interface component 124. The user interface component 124 may be a content object, such as a reusable website object. The user interface component 124 may represent a solution option on a troubleshooting user interface, and it may include any items that may be displayed on a user interface, such as links, menu buttons, or menu expansion buttons.

The database 114 may be any suitable data storage device, such as a relational database or Extensible Markup Language (XML) file. The computer 112 may communicate with the database 114, for example, via the network 116. In some implementations, data used for updating a user interface is stored in a memory of the computer 112 in addition to or instead of being stored in the database 114.

The computer 112 may include, for example, a processor 102 and machine-readable storage medium 104. As used herein, the term “machine-readable storage medium” refers to any electronic, magnetic, optical, or other physical storage device that stores executable instructions or other data (e.g., a hard disk drive, random access memory, flash memory, etc.). The processor 102 may be a central processing unit (CPU), a semiconductor-based microprocessor, or any other hardware device suitable for retrieval and execution of instructions stored in the machine-readable storage medium 104. The processor 102 may fetch, decode, and execute instructions. In some implementations, the computer 112 may include logic, such as state machine logic, instead of or in addition to the processor 102.

The machine-readable storage medium 104 may include, for example, data receiving instructions 106, user interface determining instructions 108, and outputting instructions 110. The data receiving instructions 106 may receive data from the database 114. In one embodiment, the user interface determining instructions 108 determine a user interface based on the data received by the data receiving instructions 106. The outputting instructions 110 may output data indicative of the user interface determined by the user interface determining instructions 108. The data output by the outputting instructions 110 may output data used to display the user interface 118.

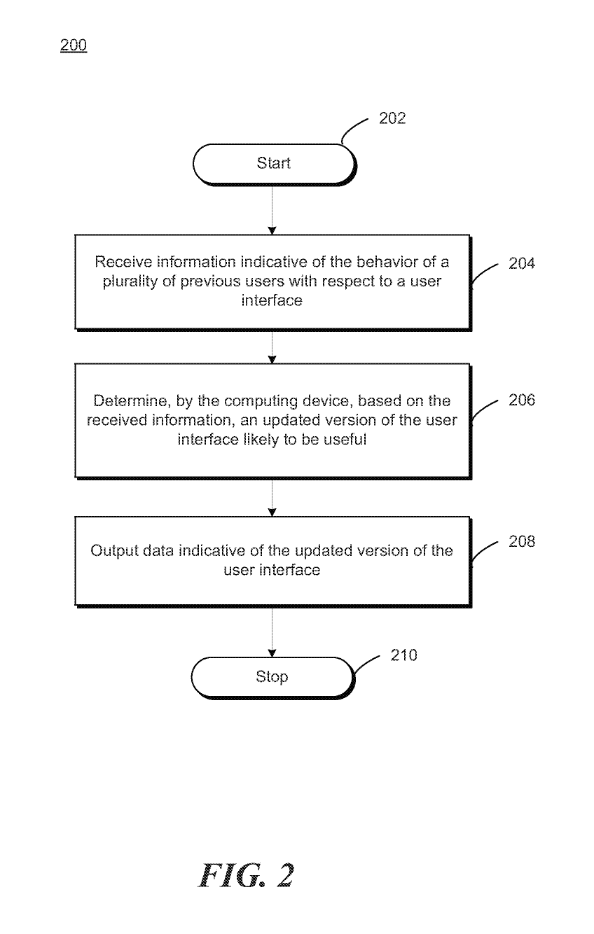

FIG. 2 is a flow chart illustrating one example of a method 200 for updating a user interface 118. The method 200 may update the user interface 118 in a manner predicted to be useful to future users. For example, the updated version of the user interface 118 may enable users to successfully find information for addressing an issue in less time or in fewer transitions, such as by accessing fewer links on the user interface 118.

The method begins at block 202 and proceeds to block 204 where the processor 102, for example by executing the data receiving instructions 106, receives information indicative of the behavior of a plurality of previous users with respect to the user interface 118. The processor 102 may receive any suitable information about the activity of multiple previous users, such as the manner in which they navigated through the user interface 118. Dividing the user interface 118 into user interface components may allow for better tracking of a previous user's behavior with respect to the user interface 118. The received information may include information about which user interface components a user selected on the user interface 118. In one embodiment, the received information includes information indicative of the frequency with which user interface components were selected on the user interface 118, such as how many users selected a particular user interface component or how many times a single user selected a user interface component. In one embodiment, the processor 102 queries the database and calculates the frequency with which a user interface component was selected.

The information received may include information indicative of the time between user interface component selections on the user interface, such as information about the length of time a page or menu was viewed. The information could indicate, for example, that items viewed for a longer period of time were more useful to users than items that were only viewed for a brief period before a user made an additional selection. In some cases, the information about items that were briefly viewed may be disregarded by the processor 102.

The received information may include information about transitions between components on the user interface 118, such as information about selections made before or after selecting a particular user interface component. For example, information that a user selected a link to contact an administrator may indicate that the user interface components that the user previously selected were not useful. In one embodiment, the received information about transitions between user interface components is indicative of the order in which components were selected on the user interface 118. For example, the information may show that after expanding menu A, 70% of users expanded menu B, and 30% of users expanded menu C. In one embodiment, the received information includes information about transitions between pairs of components. For example, the information may show the number of visits in which a user made a transition from component A to component B. In one embodiment, the processor 102 receives information indicative of the last transition on the user interface 118, such as the last viewed Uniform Resource Link (URL).

The received information may also include survey information, such as results from a survey displayed on the user interface 118. For example, information may show that for users that selected component A and then component B, 50% of them responded to a survey indicating that the user interface 118 helped the user address an issue. The survey answers may include an option for a user to show that an issue was or was not addressed using the user interface 118.

The processor 102 may receive the information by retrieving it from a memory in the computer 112 or by querying a database, such as the database 114. The processor 102 may receive information about the behavior of all of the previous users of the user interface 118 or a subset of the previous users of the user interface 118, such as the users that accessed the user interface 118 within a particular time period or for a particular purpose. In some cases, the previous users may have each accessed different versions of the user interface 118 or different portions of the user interface 118.

In one embodiment, the processor 102 receives cumulative information about the behavior of previous users. For example, the processor 102 may update or receive a mathematical weight or factor indicative of the behavior of previous users. The processor 102 may determine an updated version of the user interface 118 by analyzing a summarized weight or factor associated with previous user behavior instead of or in addition to analyzing the individual data indicative of previous user behavior.

In one embodiment, the processor 102 or other computer collects information about the use of the user interface 118 and stores it in the database 114 or other storage medium. The processor 102 may collect the information by tracking the use of the user interface 118, for example, using a click stream logger to determine mouse clicks and time between mouse clicks. The processor 102 may delimit visits to the user interface 118 for the purpose of collecting information. The processor 102 may, for example, collect data indicative of which user interface components each user viewed during each visit. Any parameter may be used to delimit a visit, such as a user identifier or a period of user inactivity.

Moving to block 206, the processor 102, such as by executing the user interface determining instructions 108, determines, based on the received information, an updated version of the user interface 118 likely to be useful. For example, the processor 102 may determine the usefulness of a past version of a user interface 118, and based on that information may predict an updated version likely to be useful for providing solutions to future users.

The processor 102 may determine an updated version of the user interface 118 based on all of the received information or based on a subset of the received information. In some cases, the processor 102 filters the received information, for example based on an input variable or statistical confidence threshold, to select a subset of the received information for use in determining an updated version of the user interface 118. For example, the processor 102 may disregard information not providing statistically meaningful information, such as information collected prior to a particular date threshold or information related to selections on the user interface 118 that were only viewed for a short time.

In one embodiment, the processor 102 filters the received information based on the determined usefulness of a past user interface. For example, the processor 102 may disregard user interface traffic related to survey results indicating that a particular version of the user interface 118 was not useful. In one embodiment, the processor 102 determines whether a past user interface meets a usefulness level indicating that it should be considered based on a parameter, such as a parameter input by an administrator or a parameter calculated by the processor 102. The parameter, for example, may be used to determine how each of the types of received information indicative of previous user behavior is determined to be relevant to the calculation. In some cases, information is counted at a fractional level if it only partially satisfies a relevancy or usefulness threshold.

In one embodiment, the processor 102 uses information about previous versions of the user interface 118 found to be not useful in order to determine an updated version of the user interface 118. The processor 102 may determine that a portion of the user interface 118 was not useful based on where a user transitioned to after a particular selection. For example, if a user selected an option to contact help support, the processor 102 may determine that previously selected items were not found to be useful. In response, the processor 102 may determine that one of the user interface components should be displayed in a manner likely to make it more visible to a user. The processor 102 may also update a portion of the user interface 118 to add an option to contact help support if it is found that the previous version was not useful to other users.

The processor 102 may determine an updated version of the user interface 118 using any suitable method. For example, the processor 102 may apply a statistical method to the received information indicative of previous user behavior or a selected subset of information indicative of previous user behavior. In one embodiment, the processor 102 uses a statistical method, such as a Markov chain, to determine a useful user interface 118. A Markov chain or other statistical method may be used to analyze transitions made by previous users and to determine the probability that a future user would make a particular transition on the user interface 118 based on the transitions made by previous users. For example, the processor 102 may apply a Markov model to a transition count indicative of previous users' transitions between user interface components, such as transitions between pairs of user interface components.

In one embodiment, the processor 102 uses information about the probability of future transitions to determine the placement of user interface components on the user interface 118. For example, the processor 102 may use a threshold parameter to determine which user interface components should be displayed. If the probability that a user would transition to a particular user interface component, such as a page, is above the threshold, the processor 102 may determine to display the user interface component or a link to the user interface component in a manner that makes it more quickly or easily accessible. For example, a first version of a user interface 118 may initially display page A containing a link to page B and a link to page C. If the processor 102 predicts that 80% of future users will transition to page C, the processor 102 may update the user interface 118 to initially display page C containing links to page A and page B.

In one embodiment, the processor 102 uses information about the probability of future transitions to determine an order for displaying user interface components on the user interface 118. For example, the processor 102 may determine the past order in which users selected user interface components and display them in the order that was most common. For example, a user interface 118 may initially display item D, then item E, than item F. If the majority of users selected item E, than item F, then item D, the processor 102 may update the user interface 118 to display item E, then item F, then item D.

In one embodiment, the processor 102 accounts for factors related to a user's behavior with respect to the user interface 118, such as the environment in which a user interacts with the user interface 118. For example, the processor 102 may account for which user interface components were displayed to a user, such as due to the size of a user's display device. If some options were not presented to a user, the processor 102 may account for this in determining an updated version of the user interface 118.

The processor 102 may account for a tendency of a user to select user interface components in the order in which they appear without evaluating the likely usefulness of each option. In some cases, the processor 102 may apply a statistical method to subtract out a preference for the current order to determine the order in which a user would select the user interface components if they were arranged in a random order. The processor 124 may perform testing, such as at random or at a regular interval, to determine whether the updated version of the user interface 118 reflects selections made in a particular order because users predicted that they would be useful or because users were selecting them in the order in which they appeared. For example, the processor 124 may select some users to show a test version of a user interface 118 different than the determined updated version of the user interface 118 in order to analyze the behavior of users with respect to the test version of the user interface 118. Such testing may be helpful, for example, if users have a clear preference for one user interface component over another.

The processor 102 may determine any suitable updated version of the user interface 118. For example, updating the user interface 118 may include selecting user interface components for display, reordering user interface components, or changing how the user interface 118 is initially displayed. The updated version of the user interface 118 may also alter the way user interface components are linked together, such as linking between pages.

In one embodiment, determining an updated version of the user interface 118 involves reorganizing existing user interface components. The processor 102 may receive information indicative of a plurality of user interface components, for example, from the database 114. The processor 102 may also receive information about the behavior of a plurality of previous users with respect to a user interface displaying one or more of the user interface components. The processor 102 may determine an updated version of the user interface 118 where the updated version is a reorganization of the received user interface components.

Reorganizing user interface components may include any manner of displaying the user interface components, for example, selecting a subset, selecting a display order, grouping, or selecting an initialized display state, such as an expanded state, for the user interface components. It may involve embedding hyperlinks, text, or other information, or highlighting user interface components. For example, if a large number of previous users continued to make additional selections after selecting menu option A, the processor 102 may determine that menu option A was not useful to previous users. As a result, the processor 102 may determine that menu option A should be displayed in a different position on the user interface 118 where it is not as prominent.

Reorganizing user interface components may include selecting not to display a particular user interface component. For example, if a large number of users select a first user interface component and then a user interface component for contacting help support, the processor 102 may determine that the user interface first component was not useful and may select not to display it. The processor 102 may also determine that another user interface was more useful and select to display the more useful user interface component instead of another one.

In some embodiments, the user interface determining instructions 108 include rules about how the user interface components can be reorganized. A rule may stipulate any suitable restriction on reorganizing the user interface components, such as that a group of user interface components should be displayed together, should not be displayed together, or should not be reordered. For example, the processor 102 may determine that a group of user interface components are locked together such that the processor 102 should not reorder them.

The processor 102 may reorganize user interface components on a single page, such as in a single view, or may reorganize how user interface components link together between pages. For example, the user interface 118 may display page X with components A, B, and C and page Y with components C, D, and E. The processor 102 may determine that the user interface 118 would be more useful for future users if page X displayed components A, B, C, and D and included a link to page Y. The processor 102 may determine that a particular user interface component should be display on the user interface 118 in multiple locations, such as determining to display component A on both page X and page Y.

In one embodiment, a user interface component represents a solution option, such as an option for addressing an issue. For example, a solution option for fixing a computer issue may include a help step for the option of restarting the computer. The user interface component representing the solution option may be any suitable user interface component, such as an expandable menu, text, or hyperlink indicating a help step.

Determining an updated version of the user interface 118 may involve dynamically producing content for the user interface 118. For example, a new user interface component may be created rather than selected from existing user interface components. The processor 102 may create new user interface components by displaying information stored in the database 114. In one embodiment, determining an updated version of the user interface 118 involves both displaying existing user interface components and creating new user interface components.

The database 114 may be continually updated with new information indicative of the behavior of previous users with respect to the user interface 118. In one embodiment, the processor 102 determines an updated version of the user interface 118 each time the user interface 118 is displayed, such as each time a website engine publishes the user interface 118. The processor 102 may determine an updated version of the user interface 118 at a predetermined interval. For example, the processor may execute the user interface determining instructions 108 each hour, day, week, or at a frequency determined by an input variable. In one embodiment, if the processor 102 does not receive enough data indicative of user behavior, for example enough data to satisfy a statistical confidence measure, the processor 102 does not execute the user interface determining instructions 108.

Determining an updated version of a user interface 118 may involve accounting for factors in addition to information received indicative of previous user behavior. For example, the processor 102 may determine that 90% of users found user interface component solution A to be useful. However, the processor 102 may detect, such as by receiving information from software running on the computer 122 or accessing data stored on the computer 122, that the particular user does not have issue A. The processor 102 may then update the user interface 118 so that the user interface component solution A is not displayed for that particular user.

Continuing to block 208, the processor 102, such as by executing the outputting instructions 110, outputs data indicative of the updated version of the user interface. The data indicative of the updated version of the user interface may be, for example, an Extensible Markup Language (XML) file or other file type readable by website publishing software. In one embodiment, the display data may be read by off the shelf software without the use of special display software.

In one embodiment, the updated version of the user interface is displayed on the display device 120, such as by the processor 102, the computer 122, or another computing device. In some cases, the computer 122 may perform additional processing on the display data received from the processor 102, such as based on an assessment as to whether a condition exists on the computer 122. For example, the computer 122 may alter which user interface components are displayed or the order in which they are displayed based on its calculations.

In some implementations, the processor 102 loads the display data into website publishing software. The processor 102 may communicate the data indicative of the updated user interface 118 to a website publishing engine that updates the website content according to its schedule. The display data may be communicated to the website publishing engine at any frequency, such as a frequency chosen by an administrator. The method may then proceed to block 210 to end.

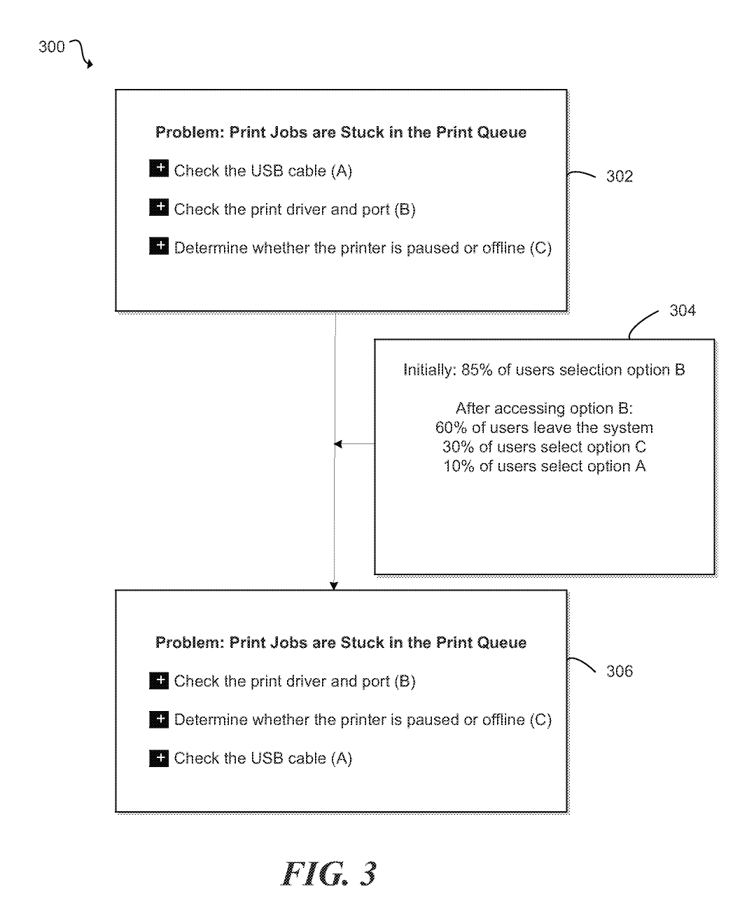

FIG. 3 is a block diagram illustrating one example of updating a user interface. FIG. 3 illustrates an initial user interface 302 showing three solution options for addressing an issue of having a print job stuck in a print queue. Block 304 illustrates some information indicative of previous user behavior with respect to the use of the user interface 302. The block 304 shows that when initially accessing the user interface 302, 85% of users selected option B to expand the instructions for checking the print driver and port. After selecting option B, 60% of those users left the system, 30% of those users selected option C to determine whether the printer is paused or offline, and 10% of those users selected option A to check the USB cable.

Based on this information, the processor 102 may determine that because a large percentage of users selected option B and than left the system, many users found that option B was useful for solving their issue. The processor 102 may further determine that after option B, users found option C to be more useful than option B because more users selected option C next. Based on its analysis, the processor 102 may determine that an updated version of the user interface 302 should display the components listing option B, then option C, and then option A. A user interface 306 illustrates an updated version of the user interface 302.

In one embodiment, the processor 102 determines a user interface 118 tailored to each of a plurality of user issues. For example, the user interface 118 may display one set of user interface components when accessed for a first purpose and may display a different set of user interface components or in a different order when accessed for a second purpose. In one embodiment, a user interface 118 initially appears the same for multiple user issues. The updated versions of the user interface may diverge over time based on the analysis of the behavior of previous users for each of the user issues. For example, the behavior of users with respect to the user interface 118 may differ based on the user issue that each user attempted to address.

The processor 102 may receive information indicative of multiple user issues, for example, from the database 114. The user issues could be any suitable user issue, such as a search request, informational topic, or troubleshooting topic. The processor 102 may receive information related to the activity of multiple previous users with respect to the user interface 118. The processor 102 may track the behavior of previous users and the user issue associated with each previous user's visit to the user interface 118.

The user interface determining instructions 108 may include instructions for predicting for each user issue, based on the information indicative of the activity of multiple previous users, an updated version of the user interface 118 likely to be useful for addressing the user issue. For example, the processor 102 may receive information about the behavior of users with respect to a portion of the user interface 118 tailored to a user issue for troubleshooting a printer issue and may also receive information about the behavior of users with respect to a portion of the user interface 118 tailored to a user issue for troubleshooting a keyboard issue.

The processor 102 may than output data indicative of each updated version of the user interface. For example, the processor 102 may output information for updating the portion of the user interface 118 tailored to the user issue for troubleshooting a printer issue and output information for updating the portion of the user interface 118 tailored to the user issue for troubleshooting a keyboard issue. The portions of the user interface may display different content or content displayed in a different manner, such as in a different order or initial display state. In one embodiment, the processor 102 determines an updated user interface 118 tailored to a requested user issue each time that the user interface 118 is displayed. The processor 102 may determine an updated portion of the user interface 118 or an updated entire user interface 118.

The processor 102 may detect a user issue facing a particular user, for example, by receiving a request input by the user or determining that the user selected a link or menu on the user interface 118. In one embodiment, the processor 102 may detect a new user issue and add it to the database 114. The processor 102 may than determine an updated version of the portion of the user interface 118 tailored to the newly added user issue.

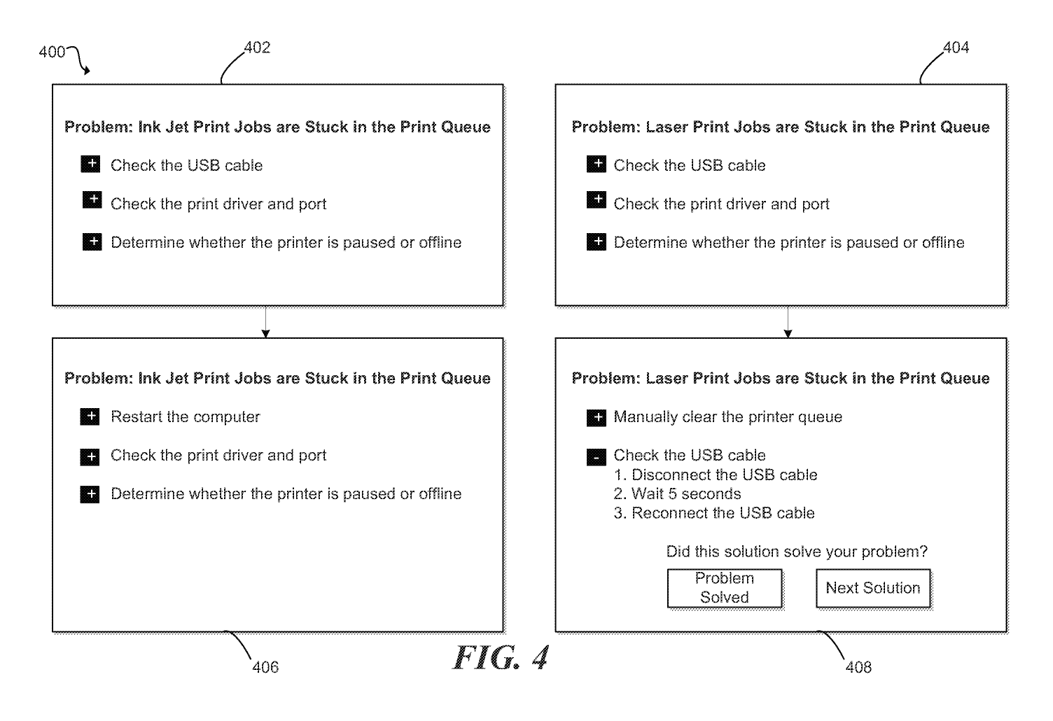

FIG. 4 is a block diagram 400 illustrating one example of updating a user interface tailored to a user issue. A user interface page 402 shows a first version of a user interface portion directed to issues with ink jet printers, and a user interface page 404 shows a first version of a user interface portion directed to issues with laser printers. The ink jet user interface page 402 and the laser user interface page 404 display the same three user interface components in the same order.

The user behavior with respect to the two user interface pages may differ, for example, because certain issues are more common to a type of printer, differing sophistication of the users of each type of printer, or other factors. The processor 102, by executing the user interface determining instructions 108, may determine that previous users of the ink jet user interface likely found “restarting the computer” instructions to be useful. For the laser printer, the processor 102 may find that many users likely found expanding the “check the USB cable” menu to be useful. The updated ink jet user interface page 406 displays different content than the updated laser user interface page 408 based on the determined updated versions of the user interface pages.

Some embodiments of updating a user interface are discussed above, but other embodiments of are also contemplated. Embodiments provide advantages. For example, some embodiments lead to more effective user interfaces that enable users to navigate through a large amount of information to locate a solution. It is desirable to have user interfaces that in addition to presenting information relevant to a user's search also present it in a manner that is useful in assisting a user to address an issue more easily and quickly. A method for updating a user interface may be effective, for example, in determining how to display a large amount of customer support information in a manner likely to assist users in addressing issues in a shorter amount of time. Such methods may grow in importance as the volume of information accessible through computers increases.

1. A computerized method for updating a user interface, comprising:
receiving, by a computing device, information indicative of the behavior of a plurality of previous users with respect to a user interface;
determining, by the computing device, based on the received information, an updated version of the user interface likely to be useful; and
outputting, by the computing device, data indicative of the updated version of the user interface.

2. The method of claim 1, wherein the received information comprises information indicative of transitions between components on the user interface.

3. The method of claim 1, further comprising displaying the updated version of the user interface based on the outputted data.

4. The method of claim 1, wherein determining an updated version of the user interface is performed each time the user interface is displayed.

5. A computing device comprising:
a processor; and
a machine-readable storage medium encoded with instructions executable by the processor for updating a user interface, the machine-readable medium comprising:
instructions for receiving information indicative of a plurality of user interface components;
instructions for receiving information indicative of the behavior of a plurality of previous users with respect to a user interface displaying one or more of the user interface components;
instructions for determining, based on the information indicative of the behavior of the plurality of previous users, an updated version of the user interface likely to be useful,
wherein instructions for determining an updated version of the user interface comprise instructions for reorganizing the user interface components; and
instructions for outputting data indicative of the updated version of the user interface.

6. The computing device of claim 5, wherein data indicative of the updated version of the user interface comprises data readable by website publishing software.

7. The computing device of claim 5, wherein instructions for receiving information indicative of the behavior of a plurality of previous users comprise instructions for receiving information indicative of transitions between the user interface components.

8. The computing device of claim 5, wherein instructions for reorganizing the user interface components comprise instructions for selecting one or more of the user interface components for display.

9. The computing device of claim 5, wherein instructions for reorganizing the user interface components comprise instructions for reordering the display order of the user interface components.

10. The computing device of claim 5, wherein instructions for reorganizing the user interface components comprise instructions for determining whether a group of user interface components may be reordered.

11. The computing device of claim 5, wherein a user interface component represents a solution option.

12. A machine-readable storage medium encoded with instructions executable by a processor for updating a user interface, the machine-readable medium comprising:
instructions for receiving information indicative of multiple user issues;
instructions for receiving information related to the activity of multiple previous users with respect to a user interface;
instructions for predicting for each user issue, based on the information indicative of the activity of multiple previous users, an updated version of the user interface likely to be useful for addressing the user issue; and
instructions for outputting data indicative of each updated version of the user interface.

13. The machine-readable storage medium of claim 12, wherein instructions for receiving information related to the activity of multiple previous users comprise instructions for receiving information indicative of transitions between components on the user interface.

14. The machine-readable storage medium of claim 12, wherein instructions for predicting an updated version of the user interface comprise instructions for selecting one or more user interface components for display.

15. The machine-readable storage medium of claim 12, wherein instructions for predicting an updated version of the user interface comprise instructions for determining an order for displaying user interface components.
